(19) United States
(12) Patent Application Publication
(10) Pub. No.: US 2010/0174520 A1
(43) Pub. Date: Jul. 8, 2010

(54) SIMULATOR

(75) Inventor: Yohei KOJIMA, Chiba-ken (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/683,362

(22) Filed: Jan. 6, 2010

(30) Foreign Application Priority Data
Jan. 7, 2009 (JP) 2009-001645

(51) Int. Cl. G06F 17/50

(52) U.S. Cl. 703/14

(57) ABSTRACT

A simulator comprising: a simulation executing unit to execute a simulation of circuit description data in which a circuit is described in a description language; a bit width monitor to monitor whether a bit width of a simulation result of an operation described in the circuit description data overflows from a bit width of an operation result assignment target variable described in the circuit description, while the simulation executing unit is executing the simulation; and an overflow avoiding unit to dynamically extend a bit width of the operation result assignment target variable that stores the simulation result, when the bit width monitor detects an occurrence of an overflow.

### CROSS-REFERENCE TO RELATED APPLICATION

This application is based upon and claims the benefit of priority from the prior Japanese Patent Application No. 2009-1645 filed in Japan on Jan. 7, 2009, the entire contents of which are incorporated herein by reference.

### BACKGROUND OF THE INVENTION

1. Field of the Invention

The present invention relates to a simulator.

2. Description of the Related Art

When a circuit description is written in a language such as a hardware description language that can specify bit widths of a register, a signal and the like, the circuit description thus written is verified by simulation. In this case, at an early stage of verification, the circuit description often has faults, and thereby an anomaly may occur in operation of a simulator. For example, when the circuit description has a bit width shorter than necessary due to an error in specifying the bit width, an overflow may occur in the simulation operation, and thereby the simulator may fall into an endless loop operation.

In such a case, the simulation must be stopped once, and then performed again after the fault in the circuit description is corrected. When the circuit description has other similar faults, the simulation stopping and the circuit description correction must be performed repeatedly every time such anomaly occurs in the simulation. Therefore, verification work is inefficient.

The anomalies of the simulation mentioned here are an overflow/underflow of the number of digits of an operation, an overflow of an array index, an endless loop, etc. It is difficult to statically detect faults in the circuit description as factors causing the anomalies and to correct these faults before executing the simulation.

In the related art, a method has been proposed in which: a simulation is firstly performed without bit widths specified; and then, appropriate bit widths are automatically specified based on a result of the simulation (for example, see Japanese Patent Application Publication No. 2006-190085, pp. 8-9, FIG. 2).

However, in the proposed method mentioned above, the bit widths are determined statically. Accordingly, when the number of times the loop is executed cannot be determined statically, a bit width for an incremental operation or another similar operation within the loop cannot be determined. For this reason, there still remains a possibility that an anomaly such as overflow may occur in the midst of the simulation, and there has been a problem that the simulation has to be stopped in order to recover from the abnormal condition.

### SUMMARY OF THE INVENTION

According to an aspect of the invention, there is provided a simulator comprising: a simulation executing unit configured to execute a simulation of circuit description data in which a circuit is described in a description language; a bit width monitor configured to monitor whether a bit width of a simulation result of an operation described in the circuit description data overflows from a bit width of an operation result assignment target variable described in the circuit description while the simulation executing unit is executing the simulation; and an overflow avoiding unit configured to dynamically extend a bit width of the operation result assignment target variable that stores the simulation result when the bit width monitor detects an occurrence of an overflow.

According to an aspect of the invention, there is provided a simulator comprising: a simulation executing unit configured to execute a simulation of circuit description data in which a circuit is described in a description language; an array monitor configured to monitor whether an index is to be assigned to an array described in the circuit description data and whether the index overflows from an array size described in the circuit description data while the simulation executing unit is executing the simulation; and an array index overflow avoiding unit configured to dynamically extend the array size when the array monitor detects the occurrence of the overflow.

According to an aspect of the invention, there is provided a simulator comprising: a simulation executing unit configured to execute a simulation of circuit description data in which a circuit is described in a description language; an endless loop monitor configured to monitor whether a loop operation described in the circuit description data has fallen into an endless loop while the simulation executing unit is executing the simulation; and an endless loop avoiding unit configured to instruct the simulation executing unit to exit from the loop operation when the endless loop monitor detects the endless loop.

### BRIEF DESCRIPTION OF THE DRAWINGS

FIG. 1 is a block diagram showing an example of a configuration of a simulator according to embodiment 1 of the present invention;

FIG. 2 is a drawing showing an example of a hardware configuration of a verification environment in which the simulator according to embodiment 1 of the present invention is used;

FIG. 3 is a flowchart showing an example of a flow of processing in the simulator according to embodiment 1;

FIG. 4 shows an example of a circuit description that may cause an overflow in an operation result;

FIG. 5 is an explanatory view of overflow avoiding processing in the simulator according to embodiment 1;

FIG. 6 is a block diagram showing an example of a configuration of a simulator according to embodiment 2 of the present invention;

FIG. 7 is a flowchart showing an example of a flow of processing in the simulator according to embodiment 2;

FIG. 8 shows an example of a circuit description that may cause an overflow of an array index;

FIG. 9 is a block diagram showing an example of a configuration of a simulator according to embodiment 3 of the present invention;

FIG. 10 is a flowchart showing an example of a flow of processing in the simulator according to embodiment 3;

FIG. 11 shows an example of a circuit description that may cause an endless loop operation;

FIG. 12 is a block diagram showing an example of a configuration of a simulator according to embodiment 4 of the present invention; and

FIG. 13 is a block diagram showing an example of a configuration of a simulator according to embodiment 5 of the present invention.

### DETAILED DESCRIPTION OF THE INVENTION

Hereinafter, embodiments of the present invention will be described with reference to the drawings. The same reference numerals will be given to the same or equivalent portions in the drawings, and description thereof will not be repeated.

### Embodiment 1

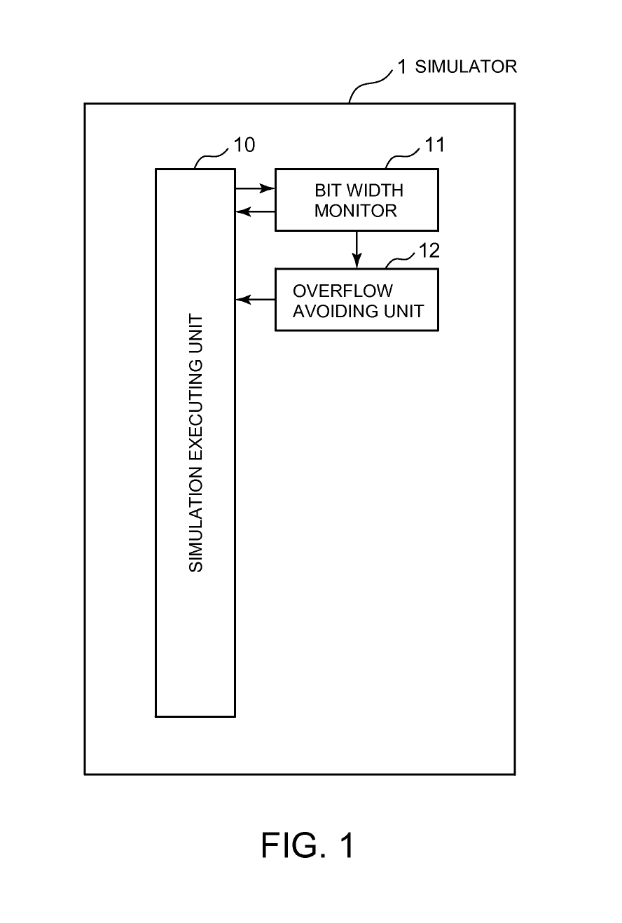

FIG. 1 is a block diagram showing an example of a configuration of a simulator according to embodiment 1 of the present invention.

The simulator 1 according to the present embodiment includes a simulation executing unit 10 to execute a simulation of circuit description data in which a circuit is described in a description language; a bit width monitor 11 to monitor whether a bit width of a simulation result of an operation described in the circuit description data overflows from a bit width of an operation result assignment target described in the circuit description, while the simulation executing unit 10 is executing the simulation; and an overflow avoiding unit 12 to perform dynamic extension of the bit width of the operation result assignment target that stores the simulation result when the bit width monitor 11 detects occurrence of an overflow.

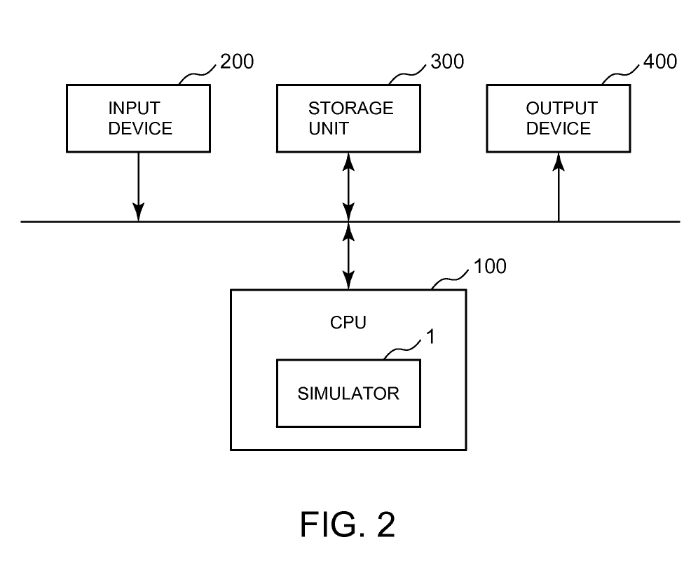

FIG. 2 is a drawing showing an example of a hardware configuration of a verification environment in which the simulator 1 according to the present embodiment is used.

Hardware of the verification environment in which the simulator 1 is used is configured of a CPU 100 to execute the simulation by the simulator 1, an input device 200 such as a keyboard and a mouse, a storage unit 300 such as a hard disk and a memory, and an output device 400 such as a display and a printer.

In order to execute the simulation of the simulator 1 by the CPU 100, the circuit description data is compiled prior to the simulation, and is stored in the storage unit 300 as a target program.

When an execute command of the simulation is inputted by the input device 200, the CPU 100 loads the target program from the storage unit 300, and starts the simulation by the simulation executing unit 10 of the simulator 1.

The simulation executing unit 10 has a program counter (PC), and executes an instruction in accordance with a value shown in the PC.

A simulation result by the simulator 1 is outputted to the output device 400, and is displayed on the display or is printed out with the printer.

The hardware configuration shown in FIG. 2 is not limited to the present embodiment, and used in common in each simulator according to the embodiments described later.

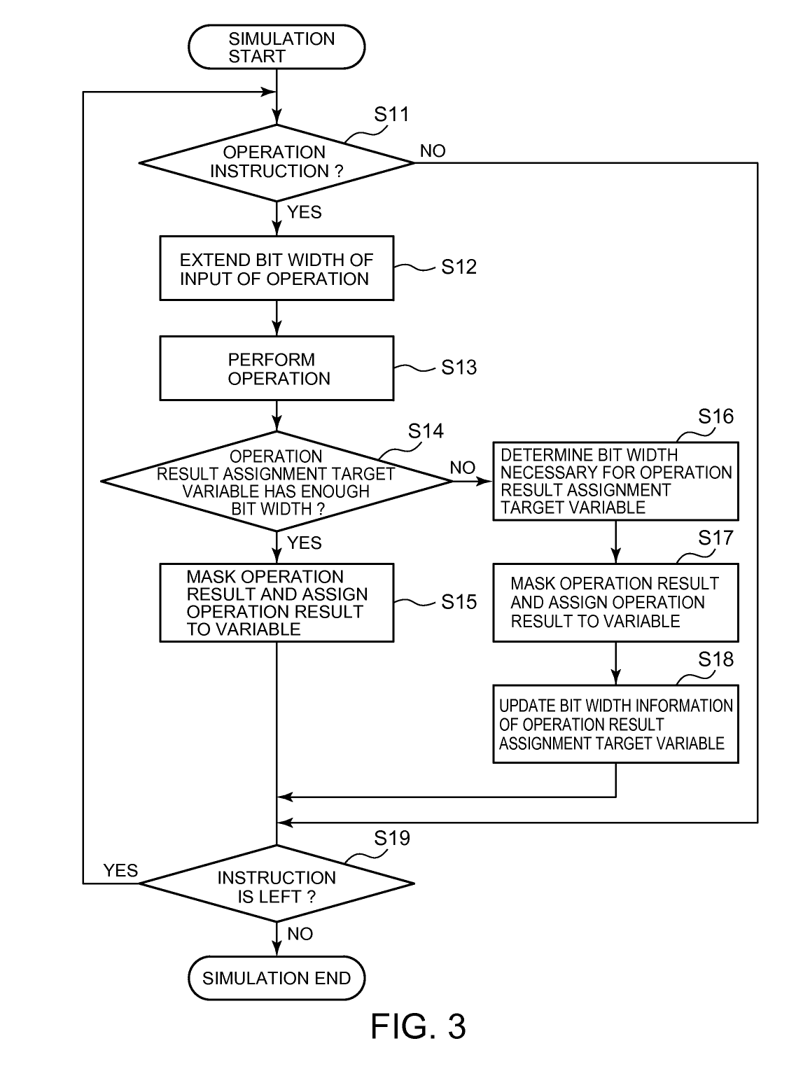

Next, using FIGS. 3 to 5, description will be given of processing in which the simulator 1 according to the present embodiment detects an overflow in the operation during the simulation execution, and avoids the overflow.

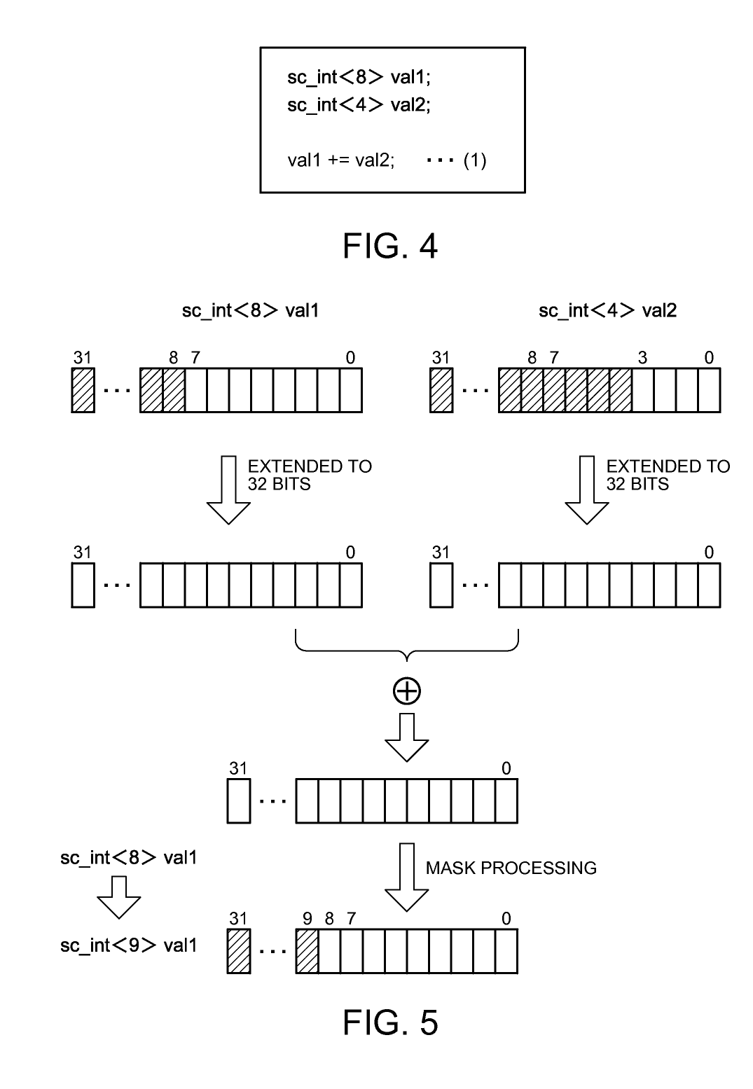

FIG. 3 is a flowchart showing an example of a flow of the processing in the simulator 1 according to the present embodiment. FIG. 4 shows an example in which a circuit description that may cause an overflow in the operation result is described using SystemC as a description language. FIG. 5 is a drawing showing a state of the processing in the present embodiment when the overflow occurs.

Here, an operation (1) is described in the circuit description shown in FIG. 4. First, an 8-bit variable val1 and a 4-bit variable val2 are defined. Subsequently, the variable val2 is added to the variable val1 and the added result is assigned to the variable val1.

While an example of a description using SystemC is shown in this example, another description language may be used as the description language.

In the flowchart shown in FIG. 3, when execution of the simulation is started, the simulation executing unit 10 checks whether or not an instruction to be executed is an operation instruction (Step S11). When the instruction is the operation instruction (YES), an input variable of the operation is extended to have a bit width treatable by the CPU 100 (for example, 32 bits) (Step S12).

At this time, ‘0’ is copied to the extended portion when the variable is an unsigned variable, and a value of a sign bit is copied to the extended portion when the variable is a signed variable.

For example, in the operation (1) of the example of the description in FIG. 4, both variables of val1 and val2 are extended to have 32 bits as shown in FIG. 5.

Subsequently, the operation is performed by the CPU 100 (Step S13). When an operation result is outputted, the bit width monitor 11 monitors the bit width of the operation result, and checks whether or not the operation result assignment target variable has an enough bit width for the bit width of the operation result (Step S14).

At this time, in the case of the unsigned variable, the bit width monitor 11 determines that the assignment target variable has an enough bit width when ‘0’ is stored in all the bits of the extended portion. Otherwise, the bit width monitor 11 determines that an overflow occurs. Moreover, in the case of the signed variable, the bit width monitor 11 determines that the assignment target variable has an enough bit width when the same value is stored in all the bits including the most significant bit of the variable to be assigned to the assignment target variable and the higher order bits than the most significant bit. Otherwise, the bit width monitor 11 determines that an overflow occurs.

When determining that the assignment target variable has an enough bit width (YES), the bit width monitor 11 transmits the determination result to the simulation executing unit 10. According to the transmitted determination result, the simulation executing unit 10 masks the operation result while leaving unmasked a bit width corresponding to the operation result assignment target variable, and subsequently assigns the resultant operation result to the operation result assignment target variable (Step S15).

For example, in the example of the description in FIG. 4, the variable val1 to be assigned the operation result is a signed variable. Therefore, when all of the seventh and higher-order bits have the same value in the operation result, it is determined that no overflow occurs. In this case, the simulation executing unit 10 masks the operation result while leaving unmasked a bit width corresponding to the variable val1 (8 bits), and assigns the value of the resultant operation result to the variable val1.

On the other hand, when determining the bit width is so short that an overflow will occur at Step S14 (NO), the bit width monitor 11 temporarily interrupts execution of the simulation of the simulation executing unit 10, and calls the overflow avoiding unit 12.

In response to this call, the overflow avoiding unit 12 first determines the bit width necessary for the operation result assignment target variable (Step S16).

At this time, the bit width necessary for an unsigned variable is determined as having the bits up to the bit of the highest-order digit having ‘1,’ whereas the bit width necessary for a signed variable is determined as having the bits up to the bit immediate left to the bit of the highest-order digit having a value different from the value of the 32nd bit.

Next, the operation result is masked with the necessary bit width thereof left unmasked, and then the resultant operation result is assigned to the operation result assignment target variable (Step S17).

For example, in the example shown in FIG. 5, the bit width of the variable val1 in the example of the description of FIG. 4 is extended by 1 bit, and is changed to 9 bits.

Subsequently, the overflow avoiding unit 12 updates bit width information on the variable val1 in the target program to the extended bit width (Step S18). Then, the simulation executing unit 10 is caused to resume the execution of the simulation. Thereby, in the next reference, the variable val1 in the example of the description of FIG. 4 is treated as a 9-bit variable.

The above-mentioned processing is iteratively executed until all the instructions of the target program are completed (Step S19).

When even the variable that has been once prevented from overflowing has a possibility of causing another overflow, the same processing is performed to extend the bit width.

According to the present embodiment mentioned above, during execution of the simulation, it is possible to detect an overflow from an operation result assignment target variable, and to dynamically extend the bit width of the variable. Thereby, an overflow in the assignment of the operation result to the variable can be avoided.

### Embodiment 2

Embodiment 1 has shown an example of the simulator capable of detecting and thereby avoiding an overflow from an operation result assignment target variable. On the other hand, the present embodiment shows an example of a simulator capable of detecting and thereby avoiding an overflow of an array index.

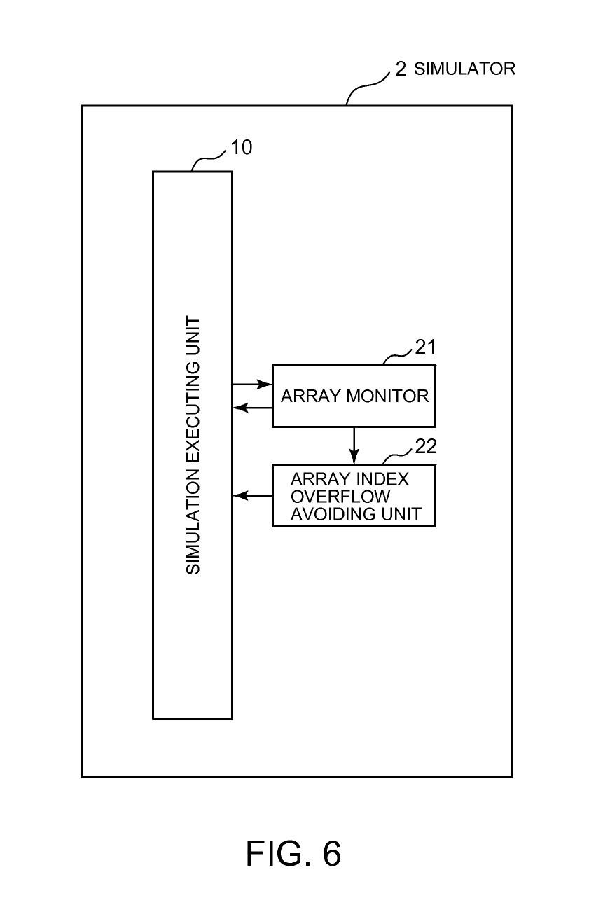

FIG. 6 is a block diagram showing an example of a configuration of the simulator according to embodiment 2 of the present invention.

The simulator 2 according to the present embodiment includes a simulation executing unit 10 similar to embodiment 1; an array monitor 21 to monitor whether or not an index of an array to be assigned, if there is any to be assigned to an array described in the circuit description data, overflows from the array size of the array described in the circuit description data, while the simulation executing unit 10 is executing the simulation; and an array index overflow avoiding unit 22 to dynamically extend the array size when the array monitor 21 detects an occurrence of the overflow.

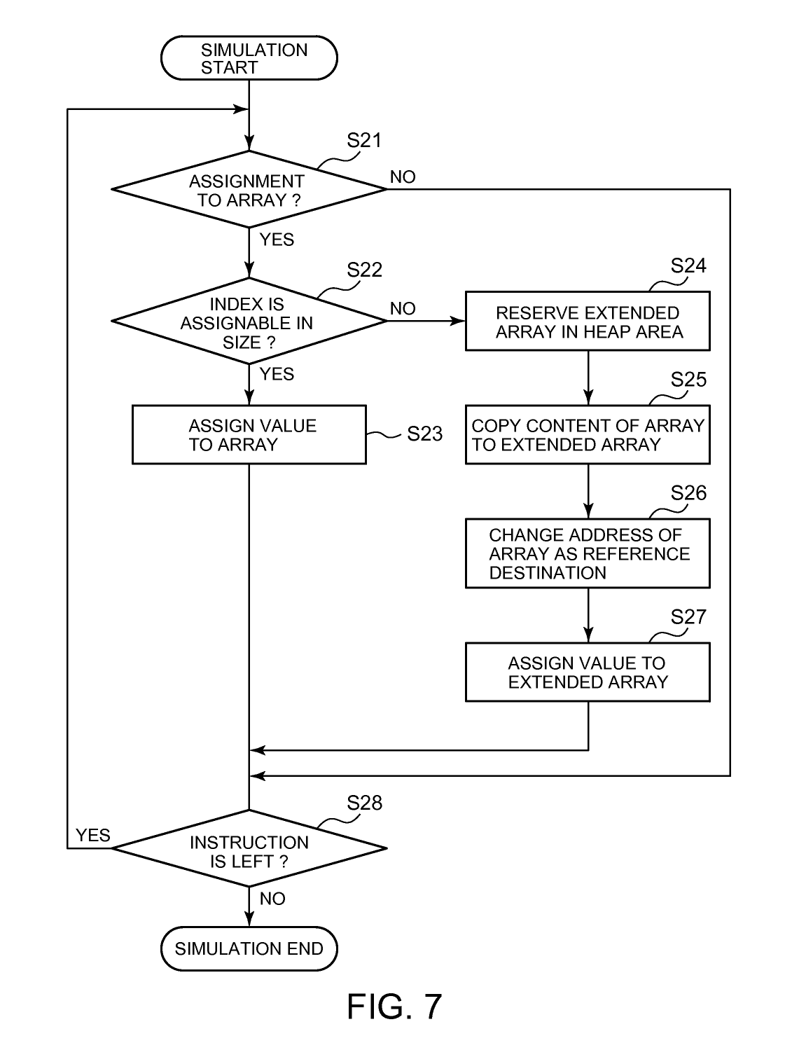

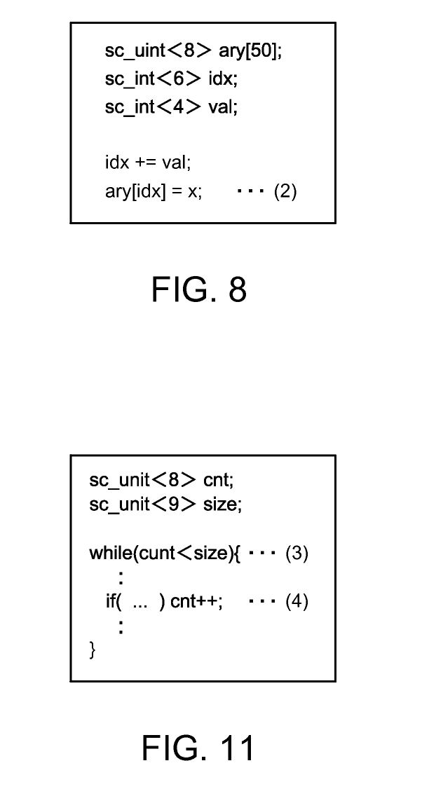

Operation of the simulator 2 will be described using, as an example, a description of an array in SystemC shown in FIG. 8 in accordance with a flow of a flowchart in FIG. 7.

In the flowchart shown in FIG. 7, after execution of the simulation is started, the array monitor 21 checks whether or not an assignment to the array is executed (Step S21).

When there is an assignment to the array (YES), the array monitor 21 further checks whether or not the index of the array to be assigned is assignable in the array size declared in the circuit description (Step S22).

For example, when an assignment to the array described in (2) of FIG. 8 is executed, the array monitor 21 checks whether or not a value of an index idx exceeds 50, which is the size of an array ary.

When determining that the index is assignable in the array size (YES), the array monitor 21 transmits the determination result to the simulation executing unit 10. According to the transmitted determination result, the simulation executing unit 10 assigns the value to a position designated by the index of the array (Step S23).

On the other hand, when determining that the index exceeds the array size (NO), the array monitor 21 temporarily interrupts execution of the simulation by the simulation executing unit 10, and calls the array index overflow avoiding unit 22.

In response to this call, the array index overflow avoiding unit 22 first reserves an array extended for the overflowing index (extended array) in a heap area of a memory (Step S24).

For example, in the example of the description of FIG. 8, when the value of the index idx is 55, the array size of 56 is necessary. Therefore, the memory for 8 bits×56 is reserved in the heap area in this case.

Next, the content of the array before the assignment is copied to the extended array reserved in the heap area (Step S25).

Subsequently, the reference address of the array is rewritten and is changed to the address of the extended array reserved in the heap area. Here, the reference address of the array is an address according to which the simulation executing unit 10 referrers to the array during execution of the simulation (Step S26).

Subsequently, the value is assigned to the position indicated by the index of this extended array (Step S27), and the simulation executing unit 10 is caused to resume the execution of the simulation.

The above-mentioned processing is repeatedly executed until all the instructions of the target program are completed (Step S28).

When even the array that has been once prevented from causing an overflow has a possibility of causing another overflow, the same processing is performed to extend the array size.

According to the present embodiment mentioned above, it is possible to detect an overflow of the array and dynamically extend the size of the array during execution of the simulation. Thereby, an overflow in the assignment of the value of the index to the array can be avoided.

### Embodiment 3

In the present embodiment, an example of a simulator capable of detecting and thereby avoiding an endless loop operation will be shown.

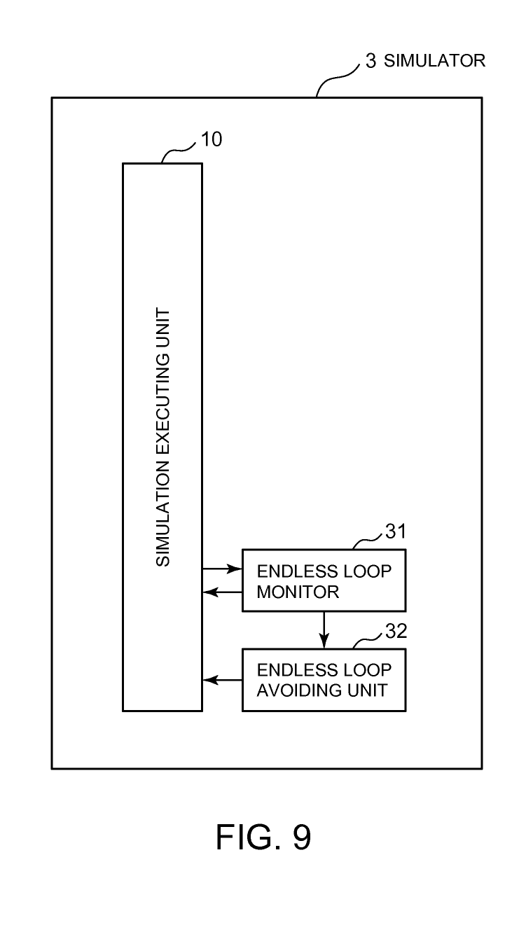

FIG. 9 is a block diagram showing an example of a configuration of the simulator according to embodiment 3 of the present invention.

The simulator 3 according to the present embodiment includes a simulation executing unit 10 similar to embodiment 1; an endless loop monitor 31 to monitor whether a loop operation described in the circuit description data has fallen into an endless loop while the simulation executing unit 10 is executing the simulation; and an endless loop avoiding unit 32 to instruct the simulation executing unit 10 to exit from the loop operation when the endless loop monitor 31 detects the endless loop.

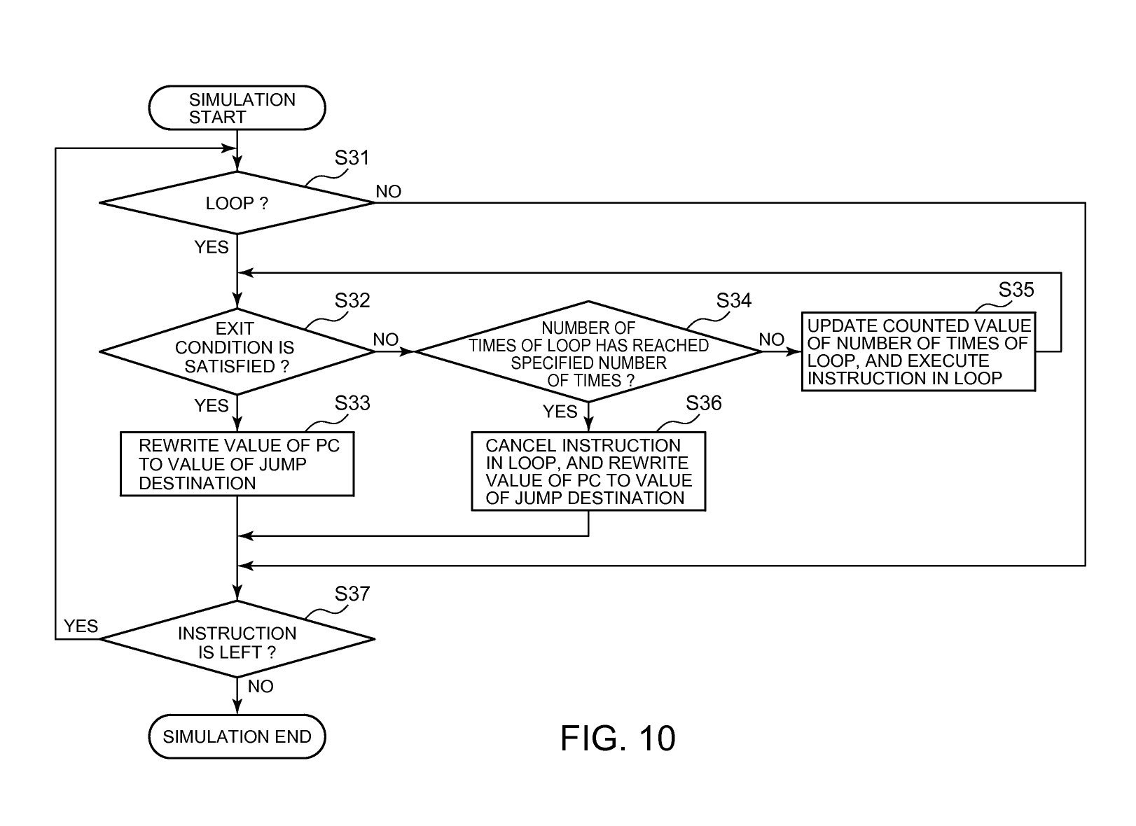

Operation of the simulator 3 will be described using a flowchart in FIG. 10.

In the flowchart shown in FIG. 10, when a loop operation is started after start of execution of the simulation (YES at Step S31), the simulation executing unit 10 checks whether or not a loop exit condition is satisfied (Step S32).

When the loop exit condition is satisfied (YES), the simulation executing unit 10 updates a value of the PC to a predetermined instruction address outside of the loop, and exits from the loop operation (Step S33).

On the other hand, when the loop exit condition is not satisfied (NO), the endless loop monitor 31 counts the number of times of the loop, and checks whether or not the counted value (the number of times of the loop) reaches a value specified by a designer in advance (the specified number of times) (Step S34).

When the number of times of the loop has not reached the specified number of times (NO), the simulation executing unit 10 continues the operation in the loop (Step S35).

On the other hand, when the number of times of the loop has reached the specified number of times (YES), the endless loop monitor 31 determines that the loop operation has fallen into the endless loop operation, temporarily interrupts execution of the simulation by the simulation executing unit 10, and calls the endless loop avoiding unit 32.

In response to this call, the endless loop avoiding unit rewrites the value of the PC of the simulation executing unit 10 to the instruction address to which the operation is to be jumped when the loop exit condition is satisfied, in order to cancel the instruction in the loop (Step S35).

Subsequently, when the simulation by the simulation executing unit 10 is resumed, the simulation executing unit 10 exits from the endless loop operation, and executes the instruction of the address specified by the PC.

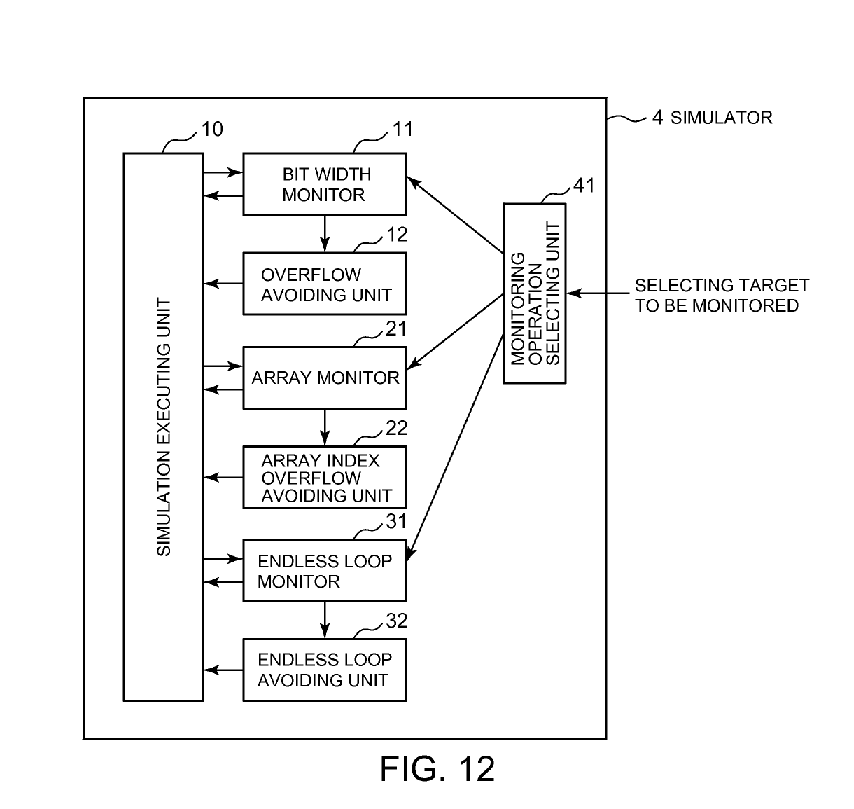

FIG. 11 shows an example of a circuit description in SystemC that may cause the endless loop operation.

In this example, the loop operation is executed in which the operation described in (4) is executed iteratively while a condition “cnt<size” described in (3) is satisfied. In other words, the exit condition of the loop operation is that “cnt≧size” is satisfied. However, there may be a case where the definitions of variables indicate that cnt is defined as a variable of 8 bits, and that size is defined as a variable of 9 bits. In this case, the condition may stay at “cnt<size”, and the exit condition “cnt≧size” may never be satisfied.

Even in such a case, by specifying an upper limit of the number of times of the loop in the endless loop monitor 31, it is possible to prevent the operation from falling into the endless loop operation.

According to the present embodiment mentioned above, it is possible to detect that the number of times of the loop operation has reached the specified number of times, and to forcibly complete the loop operation during execution of the simulation. Thereby, it is possible to prevent the ongoing operation from falling into the endless loop operation.

### Embodiment 4

FIG. 12 is a block diagram showing an example of a configuration of a simulator according to embodiment 4 of the present invention.

The simulator 4 according to the present embodiment includes the bit width monitor 11 and the overflow avoiding unit 12 shown in embodiment 1; the array monitor 21 and the array index overflow avoiding unit 22 shown in embodiment 2; and the endless loop monitor 31 and the endless loop avoiding unit 32 shown in embodiment 3. The simulator 4 further includes a monitoring operation selecting unit 41 to instruct a monitor to execute monitoring operation, the monitor being selected among the monitors of the bit width monitor 11, the array monitor 21, and the endless loop monitor 32 according to an input from the outside.

In accordance with an instruction from the outside to select a target to be monitored, the monitoring operation selecting unit 41 instructs the bit width monitor 11, the array monitor 21, and the endless loop monitor 32 to execute the monitoring operation.

More specifically, when all the three of an overflow of the operation result from the bit width of an assignment target variable, an overflow from the array size, and the endless loop operation are selected as the targets to be monitored, the monitoring operation selecting unit 41 instructs all the monitors to execute the monitoring operation. When any one of the targets to be monitored is selected, the monitoring operation selecting unit 41 instructs only the selected monitor to execute the monitoring operation. When any two of the targets to be monitored are selected, the monitoring operation selecting unit 41 instructs the selected two monitors to execute the monitoring operation.

According to the present embodiment mentioned above, even when anomalies of the simulation operation such as the overflow of an operation result from the bit width of an assignment target variable, the overflow from the array size, the endless loop operation, occur during execution of the simulation, the simulation can be executed to the end without being terminated halfway, by dynamically adding a change to the simulation target. Thereby, the number of paths that can be verified in one simulation can be increased.

Additionally, the target to be monitored can be selected depending on the content of the circuit description; for example, the overflow from the array size is not monitored for the circuit description using no array. Thereby, efficient monitoring can be performed.

### Embodiment 5

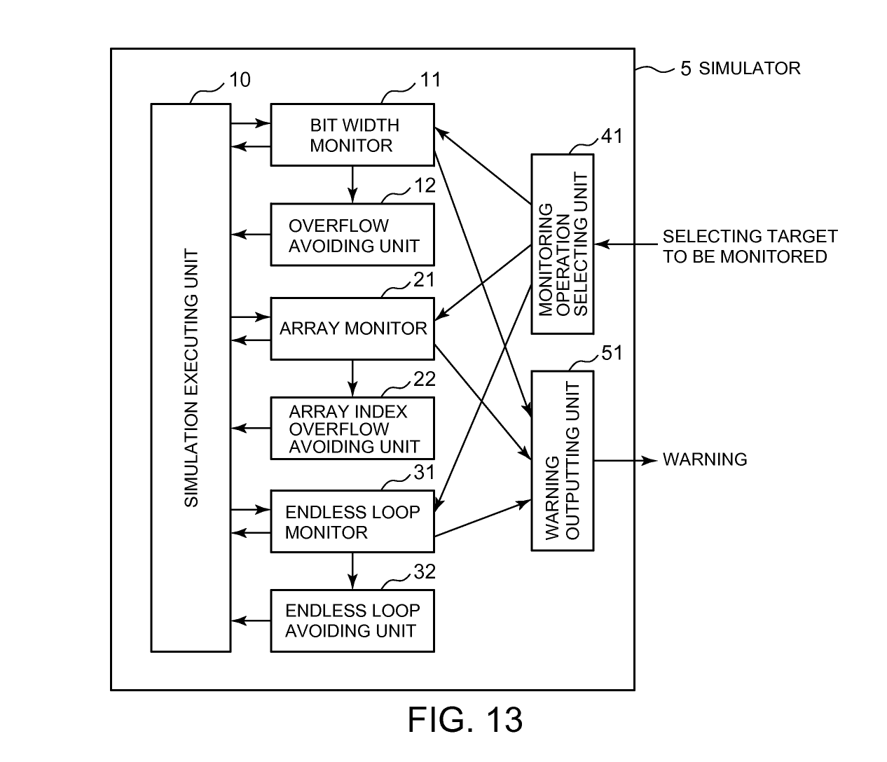

FIG. 13 is a block diagram showing an example of a configuration of a simulator according to embodiment 5 of the present invention.

In addition to the configuration of the simulator 4 according to embodiment 4, the simulator 5 according to the present embodiment further includes a warning outputting unit 51 to output a place where an anomaly occurs and the content of the anomaly to the outside as a warning when the anomaly is detected by any of the bit width monitor 11, the array monitor 21, and the endless loop monitor 32.

When an anomaly of the target to be monitored are detected in each of the bit width monitor 11, the array monitor 21, and the endless loop monitor 32, the warning outputting unit 51 outputs the place where the anomaly occurs and the content of the anomaly, as a warning, to the outside.

A circuit designer can learn which part of the circuit description has what kind of problem from display of this warning.

According to the present embodiment mentioned above, outputting the warning when an anomaly in the simulation operation occurs makes it possible to identify a faulty part in the circuit description without using a debugger or embedding a code for debugging in the circuit description.

Moreover, since multiple faults in the circuit description are detected in one simulation, the circuit designer can correct the multiple faults collectively. Thereby, the circuit designer can save himself/herself from having to stop the simulation and to correct the circuit description each time one of the faults of the circuit description is found, as in the related art. Therefore, the circuit designer can verify the circuit description efficiently.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A simulator comprising:
a simulation executing unit configured to execute a simulation of circuit description data in which a circuit is described in a description language;
a bit width monitor configured to monitor whether a bit width of a simulation result of an operation described in the circuit description data overflows from a bit width of an operation result assignment target variable described in the circuit description while the simulation executing unit is executing the simulation; and
an overflow avoiding unit configured to dynamically extend a bit width of the operation result assignment target variable that stores the simulation result when the bit width monitor detects an occurrence of an overflow.

2. The simulator according to claim 1, wherein the simulation executing unit, the bit width monitor, and the overflow avoiding unit are implemented by a CPU.

3. The simulator according to claim 2, wherein the CPU is configured to execute:
determining whether the circuit description data comprises an operation instruction;
executing the operation instruction using a bit width longer than the bit width of the operation result assignment target variable when it is determined that the circuit description data comprises the operation instruction;
determining whether the bit width of the operation result assignment target variable is sufficient for the operation result; and
extending the bit width of the operation result assignment target variable to a bit width for an assignment of the operation result when it is determined that the bit width of the operation result assignment target variable is insufficient for the operation result.

4. The simulator according to claim 1, further comprising:
an array monitor configured to monitor whether an index is to be assigned to an array described in the circuit description data and whether the index overflows from an array size described in the circuit description data while the simulation executing unit is executing the simulation;
an array index overflow avoiding unit configured to dynamically extend the array size when the array monitor detects the occurrence of the overflow;
an endless loop monitor configured to monitor whether a loop operation described in the circuit description data has fallen into an endless loop while the simulation executing unit is executing the simulation; and
an endless loop avoiding unit configured to instruct the simulation executing unit to exit from the loop operation when the endless loop monitor detects the endless loop.

5. The simulator according to claim 4, wherein the array monitor, the array index overflow avoiding unit, the endless loop monitor, and the endless loop avoiding unit are implemented by the CPU.

6. The simulator according to claim 5, wherein the CPU is configured to execute:
determining whether the circuit description data comprises an operation instruction;
executing the operation instruction using a bit width longer than the bit width of the operation result assignment target variable, when it is determined that the circuit description data comprises the operation instruction;
determining whether the bit width of the operation result assignment target variable is sufficient for the obtained operation result;
extending the bit width of the operation result assignment target variable to a bit width necessary for an assignment of the operation result, when it is determined that the bit width of the operation result assignment target variable is insufficient for the operation result;
determining whether there is an assignment to an array described in the circuit description data;
determining whether an index of an array to be assigned exceeds a size of the array described in the circuit description data when it is determined that there is an assignment to the array;
reserving an extended array having a size large enough for the assignment of the index, when it is determined that the index of the array to be assigned exceeds the size of the array described in the circuit description data;
after reserving the extended array, assigning the extended array a content of the array to be assigned, and changing a reference address of the assigned array to the address of the extended array;
determining whether the circuit description data comprises a loop operation instruction;
executing the loop operation when it is determined that the circuit description data comprises the loop operation instruction while comparing a number of executions of the loop operation with a predetermined number; and
terminating the loop operation irrespective of whether an exit condition of the loop operation is satisfied when it is determined that the number of executions of the loop operation exceeds the predetermined number.

7. The simulator according to claim 4, further comprising a monitoring operation selecting unit configured to instruct a monitor to execute a monitoring operation, the monitor being selected among the bit width monitor, the array monitor, and the endless loop monitor according to an input from outside.

8. The simulator according to claim 4, further comprising a warning outputting unit configured to output a place where an anomaly occurs and a content of the anomaly as a warning to outside when the anomaly is detected by any one of the bit width monitor, the array monitor, and the endless loop monitor.

9. The simulator according to claim 1, further comprising a warning outputting unit to output a place where an anomaly occurs and a content of the anomaly as a warning to outside when the anomaly is detected by the bit width monitor.

10. A simulator comprising:
a simulation executing unit configured to execute a simulation of circuit description data in which a circuit is described in a description language;
an array monitor configured to monitor whether an index is to be assigned to an array described in the circuit description data and whether the index overflows from an array size described in the circuit description data while the simulation executing unit is executing the simulation; and
an array index overflow avoiding unit configured to dynamically extend the array size when the array monitor detects the occurrence of the overflow.

11. The simulator according to claim 10, wherein the simulation executing unit, the array monitor, and the array index overflow avoiding unit are implemented by a CPU.

12. The simulator according to claim 11, wherein the CPU is configured to execute:
determining whether there is an assignment to an array described in the circuit description data;
determining whether an index of an array to be assigned exceeds a size of the array described in the circuit description data when it is determined that there is an assignment to the array;
reserving an extended array having a size large enough for the assignment of the index, when it is determined that the index of the array to be assigned exceeds the size of the array described in the circuit description data; and
after reserving an extended array, assigning to the extended array a content of the array to be assigned, and changing a reference address of the assigned array to the address of the extended array.

13. The simulator according to claim 10, further comprising a warning outputting unit configured to output a place where an anomaly occurs and a content of the anomaly as a warning to outside when the anomaly is detected by the array monitor.

14. A simulator comprising:
a simulation executing unit configured to execute a simulation of circuit description data in which a circuit is described in a description language;
an endless loop monitor configured to monitor whether a loop operation described in the circuit description data has fallen into an endless loop while the simulation executing unit is executing the simulation; and
an endless loop avoiding unit configured to instruct the simulation executing unit to exit from the loop operation when the endless loop monitor detects the endless loop.

15. The simulator according to claim 14, wherein the simulation executing unit, the endless loop monitor, and the endless loop avoiding unit are implemented by a CPU.

16. The simulator according to claim 15, wherein the CPU is configured to execute:
determining whether the circuit description data includes a loop operation instruction;
executing the loop operation, when it is determined that the circuit description data includes the loop operation instruction, while comparing the number of executions of the loop operation and a predetermined number; and
terminating the loop operation irrespective of whether an exit condition of the loop operation is satisfied when it is determined that the number of times of the loop operation exceeds the predetermined number.

17. The simulator according to claim 14, further comprising a warning outputting unit configured to output a place where an anomaly occurs and a content of the anomaly as a warning to outside when the anomaly is detected by the endless loop monitor.
